(19) United States
(12) Patent Application Publication
(10) Pub. No.: US 2026/0057070 A1
(43) Pub. Date: Feb. 26, 2026

(54) EMBEDDING BASED MACHINE LEARNING MODEL TO DETECT MALICIOUS CONTENT

(71) Applicant: Palo Alto Networks, Inc., Santa Clara, CA (US)

(72) Inventors: Anirban Das, San Jose, CA (US); Wenjun Hu, Santa Clara, CA (US)

(21) Appl. No.: 18/814,177

(22) Filed: Aug. 23, 2024

(51) Int. Cl. G06F 21/56

(52) U.S. Cl. CPC G06F 21/56

(57) ABSTRACT

Content is received for security analysis. At least a portion of the received content is sampled to determine a set of representative tokens. At least the set of representative tokens is embedded to determine a representative embedding. The representative embedding is applied to a machine learning model to classify the received content for the security analysis.

### BACKGROUND OF THE INVENTION

Content often needs to be analyzed to detect malicious attacks. For example, JavaScript files have a critical role in modern web pages but can be used as instruments for cybersecurity attacks, such as cross-site scripting and drive-by downloads. Malicious code is often hidden in JavaScript files and can be difficult to detect. Current cloud detection systems are proficient at detecting non-malicious JavaScript files but have high false negative rates that leave customers vulnerable to JavaScript attacks. Additionally, analyzing a large amount of content is resource intensive and inefficient. Therefore, there exists a need for more efficient and effective ways to detect malicious content.

### BRIEF DESCRIPTION OF THE DRAWINGS

Various embodiments of the invention are disclosed in the following detailed description and the accompanying drawings.

FIG. 1 is a block diagram illustrating an example of a network environment for an embedding-based machine learning (ML) model.

FIG. 2 is a flow chart illustrating an embodiment of a process for detecting malicious content by an embedding based machine learning (ML) model.

FIG. 3 is a flow chart illustrating an embodiment of a process for creating representative embedding from received content.

FIG. 4 is a flow chart illustrating an embodiment of a process for collecting and preparing training data for a security classification machine learning model.

FIG. 5 is a flow chart illustrating an embodiment of a process for training a security classification machine learning model.

FIG. 6 is a functional diagram illustrating a programmed computer system for performing security analysis using an embedding-based machine learning (ML) model.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

An embedding based machine learning (ML) model to detect malicious content is disclosed. For example, a file is analyzed to automatically identify the presence of malicious JavaScript code in the file. In some embodiments, content (e.g., JavaScript files) intercepted from data traffic between a client and a webpage are received at a cloud network. In some embodiments, the content is analyzed by an ensemble ML model containing an embedding model and a machine learning model. The embedding model is used to create embeddings representative of the content being analyzed. The representative embeddings are input to the machine learning model, which determines if there is malicious content present. Embeddings are used to efficiently capture semantic meaning without human bias and provide a solution to maintaining adherence to content retention policies. Moreover, the second machine learning model can be updated as new data is collected, allowing the detection system to stay accurate and relevant.

In some embodiments, content for security analysis is received. For example, JavaScript files intercepted from data traffic between a client and a webpage are stored in a cloud network and received by the embedding based ensemble ML model. A portion of the received content is sampled to determine a set of representative tokens. For example, unique content is identified from the received content and tokenized to reduce the sample size while maintaining its linguistic significance. At least the set of representative tokens is embedded to determine a representative embedding. For example, a set of tokens for each file is selected and embedded to create a representative embedding of the file. The representative embedding is applied to a machine learning model to classify the received content for the security analysis. For example, a machine learning model classifies representative embeddings as containing malicious code or benign. By using an embedded representative sample of the content instead of the original content, less data needs to be stored and processed, leading to processing efficiency. The embedding also obfuscates content, allowing the embedding to be stored and utilized longer than allowed by privacy and/or data retention policies. Additionally, reducing the content to its unique representative embedding leads to improved machine learning classification results by minimizing non-representative content from being considered in the machine learning classifications.

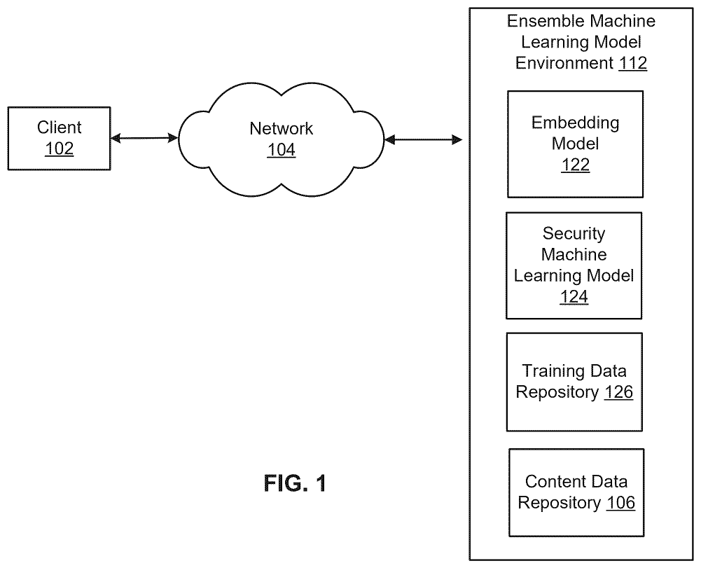

FIG. 1 is a block diagram illustrating an example of a network environment for performing security analysis using an embedding-based machine learning (ML) model. In the example shown, client 102 and ensemble machine learning model environment 112 are connected via network 104. Network 104 can be a public or private network. In some embodiments, network 104 is a public network such as the internet. Examples of network 104 include one or more of the following: a direct or indirect physical communication connection, internet, intranet, Local Area Network, Wide Area Network, Storage Area Network, and any other form of connecting two or more systems, components, or storage devices together. In various embodiments, ensemble machine learning model environment 112 includes embedding model 122, security machine learning model 124, training data repository 126, and content data repository 106. In some embodiments, embedding model 122 and security machine learning model 124 are used to implement malicious content detection. Ensemble machine learning model environment 112 is communicatively connected to client 102 and offers its malicious JavaScript detection service to clients such as client 102. For example, ensemble machine learning model environment 112 can analyze, classify, and manage the data stored in content data repository 106.

In some embodiments, client 102 is an example client for accessing the malicious content detection service offered by ensemble machine learning model environment 112. For example, client 102 can be a network device such as a desktop computer, a laptop, a tablet, or another network computing device. As a network device, client 102 can upload data to content data repository 106 to be processed by the malicious content detection service of ensemble machine learning model environment 112. Client 102 can also access, execute, or send the data in content data repository 106, unless blocked by ensemble machine learning model environment 112. In some embodiments, client 102 is protected by a firewall that invokes services of ensemble machine learning model environment 112 to determine whether content attempted to be accessed by client 102 is malicious. For example, content attempted to be accessed by client 102 is indicated to ensemble machine learning model environment 112 by the firewall and the ensemble machine learning model environment 112 obtains (e.g., stored in repository 106) and analyzes the content before providing a security analysis result to the firewall that can either block or allow the access based on the security analysis result. The firewall is a network security device that monitors and controls incoming and outgoing network traffic. It may act as a barrier between client 102 and an untrusted network. The firewall can be implemented as hardware, software, or a combination of both.

In some embodiments, content data repository 106 provides client files, such as files from client 102, to ensemble machine learning model environment 112. For example, client 102 uses network 104 to access data in content data repository 106, and ensemble machine learning model environment 112 executes its malicious JavaScript detection service on the files in content data repository 106. In various embodiments, content data repository 106 is a storage system (e.g., a database, file system, or cloud-based storage system). In some embodiments, files stored in content data repository 106 are deleted after a specified period of time to adhere to content retention policies while embeddings of the files that are effectively obfuscated versions of the files are stored beyond the specified period of time of original content retention policies.

In some embodiments, ensemble machine learning model environment 112 includes a group of two or more machine learning models used to implement a malicious JavaScript detection service. In the example shown, ensemble machine learning model environment 112 includes embedding model 122, security machine learning model 124, and training data repository 126. In some embodiments, embedding model 122 is communicatively connected to security machine learning model 124, and the input for security machine learning model 124 is the output of embedding model 122. In some embodiments, the output of embedding model 122 is stored in training data repository 126, and the data in training repository 126 is used to train security machine learning model 124.

In some embodiments, the components shown in FIG. 1 may exist in various combinations of hardware machines. Although single instances of some components have been shown to simplify the diagram, additional instances of the components shown in FIG. 1 may exist. For example, ensemble machine learning model environment 112 can include one or more servers including one or more servers for embedding model 122, security machine learning model 124, and training data repository 126. The included servers can include distributed servers, application servers, and database servers, among others. As shown in FIG. 1, client 102 is just one example of a potential client to ensemble machine learning model environment 112. In some embodiments, components not shown in FIG. 1 may also exist.

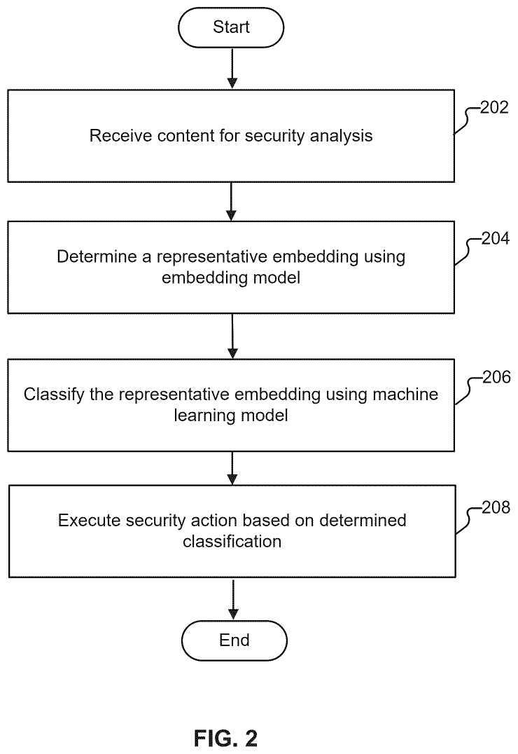

FIG. 2 is a flow chart illustrating an embodiment of a process for detecting malicious content by an embedding based machine learning (ML) model. For example, using the process of FIG. 2, the embedding based ML model can detect malicious JavaScript code from received content. In some embodiments, the process of FIG. 2 is executed by ensemble machine learning model environment 112 of FIG. 1. In some embodiments, the process of FIG. 2 is performed when client 102 of FIG. 1 attempts to access data in content data repository 106 of FIG. 1.

At 202, content for security analysis is received. For example, content is received by ensemble machine learning model environment 112 from content data repository 106 via network 104 of FIG. 1. In some embodiments, the content includes JavaScript content. For example, the content includes JavaScript files corresponding to a web page that a client is connected to. In some embodiments, the content contains malicious JavaScript that can be executed by a client, such as client 102 of FIG. 1. In some embodiments, the content received was automatically or manually uploaded by a client, such as client 102 of FIG. 1 during their attempt to connect to a web page. Examples of content include program code, web programming language code, JavaScript, Python code, Structure Query Language code, Swift code, C #code, HTML5 code, CSS code, PHP code, a message, and any other user provided content.

At 204, a representative embedding is determined using an embedding model. The representative embedding is associated with the content received at 202. For example, the received content or a portion of the received content is input to the embedding model and the associated embeddings are output. In some embodiments, the received content at 202 is processed before it is input into the embedding model. For example, an algorithm is applied to tokenize the content and at least a portion of the tokens are embedded. In some embodiments, a sampled portion of the content is embedded using the embedding model. For example, portions of the content from specified locations (e.g., beginning, middle, and end of the content) are extracted and each embedded using the embedding model. These embeddings can be combined/aggregated (e.g., concatenated) as the representative embedding. In some embodiments, the representative embedding is vectors, matrices, or any other data structures used to represent embeddings. In some embodiments, the embedding model is an embedding model trained using multiple programming languages. In some embodiments, the embedding model is embedding model 122 of FIG. 1.

At 206, the representative embedding is classified using a machine learning model. For example, the representative embedding is input to the machine learning model (e.g., different from the model used to create the representative embedding) and the machine learning model outputs whether the representative embedding is classified as being associated with malicious content. In some embodiments, the determined classification of the representative embedding is of a particular malicious content type selected among a plurality of the malicious content types. In some embodiments, classifying the representative embeddings includes determining a confidence score associated with whether the representative embedding is malicious. For example, the machine learning model assigns a received representative embedding with a confidence score, and the confidence score is used to classify the representative embeddings. In some embodiments, a threshold value for the confidence score is used to classify whether a representative embedding is malicious or benign. For example, a threshold value is determined and validated during the training of the machine learning model. In some embodiments, the machine learning model is specifically trained to classify representative embeddings on whether they are malicious. For example, the machine learning model is trained to determine whether the representative embedding contains malicious content. In some embodiments, the machine learning model is security machine learning model 124 of FIG. 1.

At 208, a security action is executed based on the determined classification. For example, a user is either protected from or allowed to interact with content depending on the classification of the content determined at 206. In some embodiments, the security action performed in response to the content being classified as malicious or containing malicious components includes blocking the received content from being accessed, executed, or sent by an end-user. For example, the received content is made inaccessible by client 102 of FIG. 1. In some embodiments, the security action performed in response to the content being classified as malicious or containing malicious components includes modifying the content to remove a malicious portion. In some embodiments, the security action performed in response to the content being classified as benign includes allowing the content to be accessed, executed, or sent by a user (e.g., client 102 of FIG. 1).

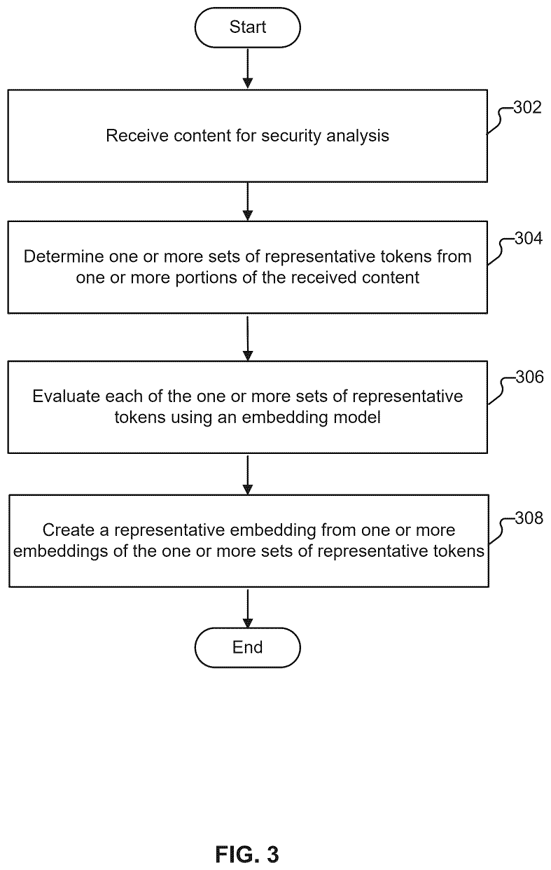

FIG. 3 is a flow chart illustrating an embodiment of a process for creating representative embedding from received content. For example, using the process of FIG. 3, received content is processed and embedded in preparation for classification performed downstream. In some embodiments, the process of FIG. 3 is executed by embedding model 122 of FIG. 1. In some embodiments, at least a portion of the process of FIG. 3 is included in 204 of FIG. 2. In some embodiments, the process of FIG. 3 is performed as a service to customers like client 102 of FIG. 1. In some embodiments, the process of FIG. 3 is used to create training data for the machine learning model.

At 302, content for security analysis is received. In some embodiments, the content includes web code content. For example, the content includes JavaScript files corresponding to a web page that a client is connected to. In some embodiments, the content contains malicious code content that can be executed by a client, such as client 102 of FIG. 1. In some embodiments, the content received was automatically or manually uploaded by a client, such as client 102 of FIG. 1 during their attempt to connect to a web page. In some embodiments, the content includes test content to be used to train a malicious content classification model. Examples of the received content in various embodiments include program code, web programming language code, JavaScript, Python code, Structure Query Language code, Swift code, C #code, HTML5 code, CSS code, PHP code, a message, and any other user provided content.

At 304, one or more sets of representative tokens are determined from one or more portions of the received content. In some embodiments, if a size of the received content is below a threshold, a set of representative tokens are identified from the entire received content. In some embodiments, one or more portions of the received content that are representative of the content are identified and each of the one or more portions are converted into a corresponding set of the tokens. For example, a fixed amount of content at a beginning, an end, and a calculated middle of the received content are identified as the portions and words in each of these portions are identified as one of the sets of representative tokens. In some embodiments, identifying the one or more portions of the received content includes analyzing the received content to identify one or more portions that are most varied and/or different from other portions within the received content or with respect to other content in a content collection or repository. In some embodiments, the one or more portions of the received content are of a specified fixed size. In some embodiments, determining a set of representative tokens for at least a portion of the received content includes preprocessing at least the portion of the received content to remove formatting/punctuation characters, remove stop words (e.g., articles, conjunctions, prepositions, pronouns, auxiliary verbs, etc.), and/or standardize words or formatting (e.g., capitalization). The preprocessed content portion then can be tokenized into word tokens, sentence tokens, code line tokens, and/or fixed character size tokens. Because the received content is converted into representative tokens, the semantic meaning of the received content is preserved while standardizing the vocabulary of the received content. Sampling portions of the received content to prepare as input for the embedding model ensures that the embedding model performs at a reasonable speed and that the set of representative tokens capture the main components of the received content.

At 306, each of the one or more sets of representative tokens are evaluated using an embedding model. For example, each determined set of representative tokens from 304 is input to a machine learning embedding model and their embedding vector is determined. In various embodiments, the embedding of each of the one or more sets of representative tokens is output as a vector, a matrix, or any other data structure used to represent an embedding. In some embodiments, each embedding is represented as a multidimensional of the same number of dimensions. In some embodiments, the embedding model is an embedding model trained using multiple programming languages (e.g., including JavaScript). In some embodiments, the embedding model is embedding model 122 of FIG. 1.

At 308, representative embedding is created from one or more embeddings of the one or more sets of representative tokens. In some embodiments, the one or more embeddings determined in 306 are combined to create the representative embedding of the content. For example, the embeddings of the sets of representative tokens associated with the beginning, calculated middle, and end of the received content are concatenated to create one representative embedding. In some embodiments, combining the one or more embeddings of the one or more sets of representative tokens includes differently weighing the one or more embeddings of the one or more sets of representative tokens. For example, weighted averaging is performed to combine the one or more embeddings of the one or more sets of representative tokens.

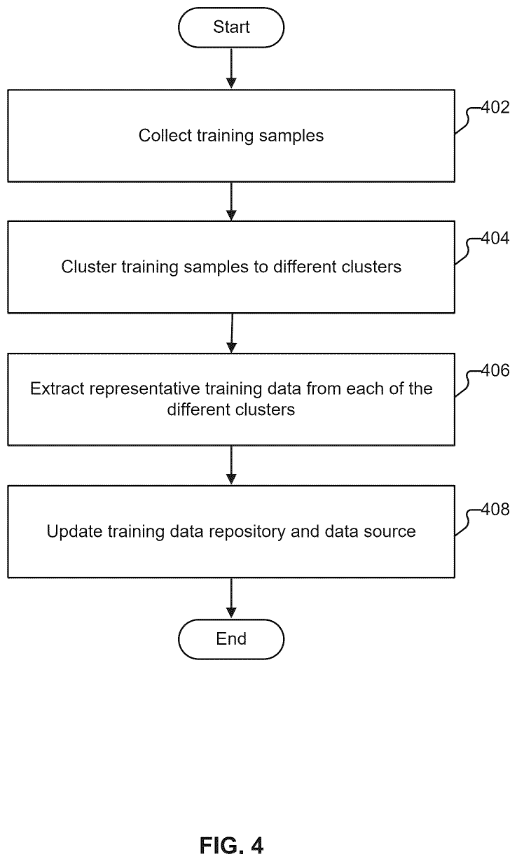

FIG. 4 is a flow chart illustrating an embodiment of a process for collecting and preparing training data for a security classification machine learning model. For example, using the process of FIG. 4, data is collected, processed, and stored in a training dataset for the security classification machine learning model. In some embodiments, the training data is for a machine learning model that classifies its input as malicious or benign. In some embodiments, at least part of the process of FIG. 4 is executed by embedding model 122 of FIG. 1.

At 402, training samples are collected. For example, files are collected and stored to be used as training samples. In some embodiments, the training samples are collected from a specified period of time. In some embodiments, the training samples are collected from content data repository 106 of FIG. 1. In some embodiments, training samples are files collected from a user's attempt to connect to a web page.

At 404, training samples are clustered to different clusters. For example, training samples are grouped into clusters based on similarity. In some embodiments, training samples of the same file name and file size are grouped together. For example, file names are standardized and compared to determine the files with the same file name. Each cluster represents a group of files that are likely duplicates of each other.

A 406, representative training data is extracted from each of the different clusters. For example, training data representing one or more files from each cluster is extracted. In some embodiments, one file from each cluster is selected to become representative training data to reduce the number of duplicate training samples. In some embodiments, extracting representative training data includes determining the embedding of the selected file. For example, the selected file is embedded using an embedding model. In some embodiments, the representative training data is the embedding data of the selected file. In some embodiments, the embedding of the selected file is determined using the process of FIG. 3. In some embodiments, 406 is executed by embedding model 122 of FIG. 1. In some embodiments, extracting representative training data includes determining ground truth labels. For example, the embedding data of the selected file is paired with a label associated with the output of the machine learning model. In some embodiments, the labels describe whether the file contains malicious code. In some embodiments, the labels are determined manually or by existing malicious content detection systems. In some embodiments, the representative training data includes the assigned label.

At 408, the training data repository and data source are updated. In some embodiments, the training data repository is updated with the extracted representative training data from 406. For example, the training data repository is updated with embedding data and ground truth labels from the training samples, which can be stored beyond the content retention policy period for the original content. In some embodiments, the updated data source is the location in which the training samples were originally stored. In some embodiments, updating the data source comprises deleting the original training data that was processed at 404 and 406 to adhere to content retention policies. In some embodiments, the training data repository is training data repository 126 of FIG. 1. In some embodiments, the data source is content data repository 106 of FIG. 1.

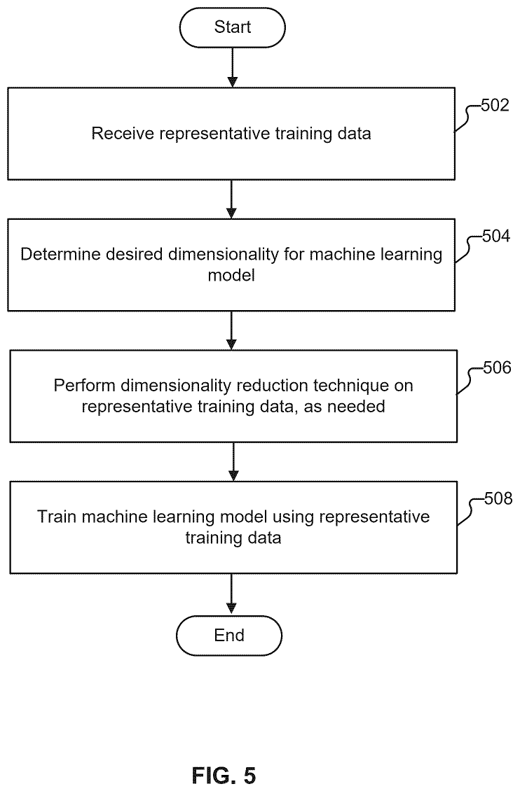

FIG. 5 is a flow chart illustrating an embodiment of a process for training a security classification machine learning model. For example, using the process of FIG. 5, data post-processing is performed on the training data, and the security classification machine learning model is trained on the processed training data. In some embodiments, the process of FIG. 5 is executed by security machine learning model 124 of FIG. 1. In some embodiments, the process of FIG. 5 is executed after the process of FIG. 4. In some embodiments, the process of FIG. 5 is executed before 206 of FIG. 2.

At 502, representative training data is received. In some embodiments, the representative training data is from training data repository 126 of FIG. 1. In some embodiments, the received representative training data is embedding data. For example, the representative training data is embedding data of files. In some embodiments, the representative training data includes a label associated with the desired outcome or output of the machine learning model. For example, labels are attached to the embedding data detailing whether it contains malicious code.

At 504, a desired dimensionality for the machine learning model is determined. For example, a specified scalar value is determined as the desired dimension for the machine learning model. In some embodiments, the determined dimension is associated with the size of the available training dataset. In some embodiments, the determined dimension is associated with the dimensions of the representative training data received. For example, the determined dimension is associated with the dimension of the embedding data. In some embodiments, the determined dimension impacts the time required to train the machine learning model. For example, the determined dimension is a smaller value, reducing the number of computational resources required to train the machine learning model.

At 506, a dimensionality reduction technique is performed on representative training data as needed. For example, a dimensionality reduction technique is applied to representative training data to reduce the number of dimensions. In some embodiments, the dimensionality reduction technique is principal component analysis, random projections, or any other technique used to transform data from a higher dimensional space into a lower dimensional space. In some embodiments, the dimensionality reduction technique is performed to ensure that the representative training data can fit the dimension of the machine learning model determined at 504.

At 508, a machine learning model is trained using the representative training data. In some embodiments, the representative training data is split into multiple datasets. For example, the representative training data is split into a training, cross-validation, and testing dataset. In some embodiments, the dataset split is based on the period of time the representative training data was collected from. In some embodiments, the dataset split is based on determined ratios standard for machine learning. The machine learning model is trained using the training dataset. In some embodiments, a threshold probability to classify content as malicious is determined using the cross-validation set. For example, the threshold probability is a value associated with a confidence score output by the machine learning model that a file contains malicious code or is malicious. The machine learning model is tested using the testing dataset. In some embodiments, during the testing of the machine learning model, performance analytics are measured including but not limited to a confusion matrix. In some embodiments, the machine learning model is security machine learning model 124 of FIG. 1.

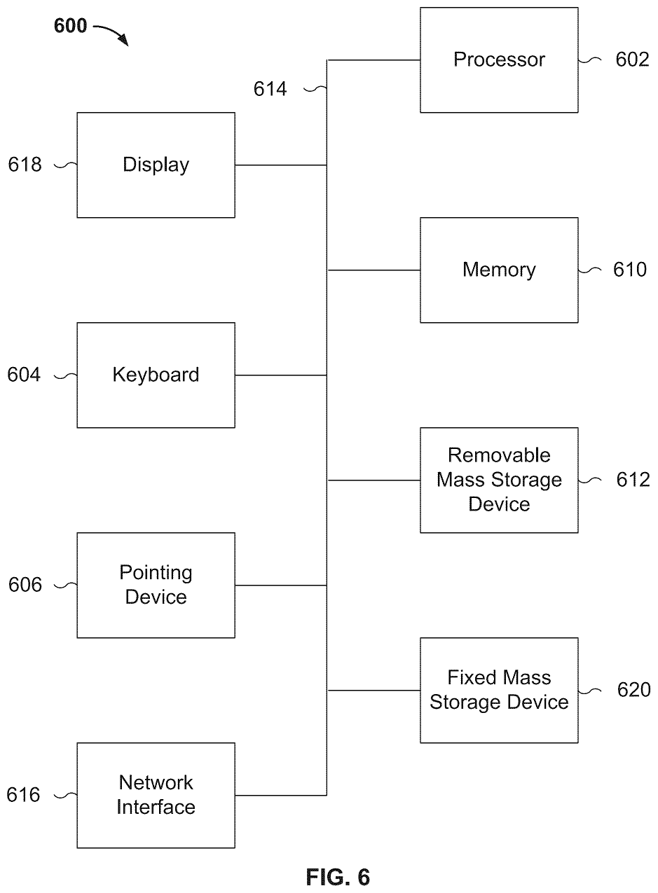

FIG. 6 is a functional diagram illustrating a programmed computer system for performing security analysis using an embedding-based machine learning (ML) model. As will be apparent, other computer system architectures and configurations can be utilized for performing related entity record resolution and entity resolution using machine learning models. Examples of computer system 600 include client 102 of FIG. 1, one or more computers used to implement content data repository 106 of FIG. 1, one or more computers used to implement ensemble machine learning model environment 112 of FIG. 1, one or more computers used to implement embedding model 122 of FIG. 1, one or more computers use to implement security machine learning model 124 of FIG. 1, and one or more computers used to implement training data repository 126 of FIG. 1. Computer system 600, which includes various subsystems as described below, includes at least one microprocessor subsystem (also referred to as a processor or a central processing unit (CPU)) 602. For example, processor 602 can be implemented by a single-chip processor or by multiple processors. In some embodiments, processor 602 is a general purpose digital processor that controls the operation of the computer system 600. Using instructions retrieved from memory 610, the processor 602 controls the reception and manipulation of input data, and the output and display of data on output devices (e.g., display 618). In various embodiments, one or more instances of computer system 600 can be used to implement at least portions of the processes of FIGS. 2 through 5.

Processor 602 is coupled bi-directionally with memory 610, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 602. Also as is well known in the art, primary storage typically includes basic operating instructions, program code, data and objects used by the processor 602 to perform its functions (e.g., programmed instructions). For example, memory 610 can include any suitable computer-readable storage media, described below, depending on whether, for example, data access needs to be bi-directional or unidirectional. For example, processor 602 can also directly and very rapidly retrieve and store frequently needed data in a cache memory (not shown).

A removable mass storage device 612 provides additional data storage capacity for the computer system 600, and is coupled either bi-directionally (read/write) or unidirectionally (read only) to processor 602. For example, storage 612 can also include computer-readable media such as magnetic tape, flash memory, PC-CARDS, portable mass storage devices, holographic storage devices, and other storage devices. A fixed mass storage 620 can also, for example, provide additional data storage capacity. The most common example of mass storage 620 is a hard disk drive. Mass storages 612, 620 generally store additional programming instructions, data, and the like that typically are not in active use by the processor 602. It will be appreciated that the information retained within mass storages 612 and 620 can be incorporated, if needed, in standard fashion as part of memory 610 (e.g., RAM) as virtual memory.

In addition to providing processor 602 access to storage subsystems, bus 614 can also be used to provide access to other subsystems and devices. As shown, these can include a display monitor 618, a network interface 616, a keyboard 604, and a pointing device 606, as well as an auxiliary input/output device interface, a sound card, speakers, and other subsystems as needed. For example, the pointing device 606 can be a mouse, stylus, track ball, or tablet, and is useful for interacting with a graphical user interface.

The network interface 616 allows processor 602 to be coupled to another computer, computer network, or telecommunications network using a network connection as shown. For example, through the network interface 616, the processor 602 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 602 can be used to connect the computer system 600 to an external network and transfer data according to standard protocols. For example, various process embodiments disclosed herein can be executed on processor 602, or can be performed across a network such as the Internet, intranet networks, or local area networks, in conjunction with a remote processor that shares a portion of the processing. Additional mass storage devices (not shown) can also be connected to processor 602 through network interface 616.

An auxiliary I/O device interface (not shown) can be used in conjunction with computer system 600. The auxiliary I/O device interface can include general and customized interfaces that allow the processor 602 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 6 is but an example of a computer system suitable for use with the various embodiments disclosed herein. Other computer systems suitable for such use can include additional or fewer subsystems. In addition, bus 614 is illustrative of any interconnection scheme serving to link the subsystems. Other computer architectures having different configurations of subsystems can also be utilized.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving content for security analysis;
sampling a portion of the received content to determine a set of representative tokens;
embedding at least the set of representative tokens to determine a representative embedding; and
applying the representative embedding to a machine learning model to classify the received content for the security analysis.

2. The method of claim 1, wherein applying the representative embedding to classify the received content includes determining a confidence score associated with whether the received content is malicious.

3. The method of claim 1, wherein the content includes JavaScript content, and the received content is classified as either a malicious JavaScript or a non-malicious JavaScript.

4. The method of claim 1, further comprising performing a security action in response to a result of the classification, wherein the security action includes blocking the received content from being accessed, executed, or sent.

5. The method of claim 1, wherein the sampled portion of the received content is from a specified location within the received content associated with a beginning, an end, or a calculated middle of the received content.

6. The method of claim 1, wherein embedding the at least set of representative tokens to determine the representative embedding includes embedding different sets of representative tokens from different portions of the received content to determine different embedding portions that are combined to be the representative embedding.

7. The method of claim 1, further comprising:
collecting training samples;
clustering the training samples to different clusters;
extracting representative training data from each of the different clusters; and
using the representative training data to train the machine learning model.

8. The method of claim 7, wherein the training samples are embedding data.

9. The method of claim 7, wherein using the representative training data to train the machine learning model includes performing principal component analysis or random projections to reduce a dimensionality of the machine learning model.

10. The method of claim 1, further comprising deleting the received content within a content retention policy period but storing the representative embedding beyond the content retention policy period.

11. A system, comprising;
a processor configured to:
receive content for security analysis;
sample a portion of the received content to determine a set of representative tokens;
embed at least the set of representative tokens to determine a representative embedding; and
apply the representative embedding to a machine learning model to classify the received content for the security analysis; and
a memory coupled to the processor and configured to provide the processor with instructions.

12. The system of claim 11, wherein applying the representative embedding to classify the received content includes determining a confidence score associated with whether the received content is malicious.

13. The system of claim 11, wherein the content includes JavaScript content, and the received content is classified as either a malicious JavaScript or a non-malicious JavaScript.

14. The system of claim 11, wherein the processor is further configured to initiate a security action in response to a result of the classification, wherein the security action includes blocking the received content from being accessed, executed, or sent.

15. The system of claim 11, wherein the sampled portion of the received content is from a specified location within the received content associated with a beginning, an end, or a calculated middle of the received content.

16. The system of claim 11, wherein embedding the at least set of representative tokens to determine the representative embedding includes embedding different sets of representative tokens from different portions of the received content to determine different embedding portions that are combined to be the representative embedding.

17. The system of claim 11, wherein the processor is further configured to:
collect training samples;
cluster the training samples to different clusters;
extract representative training data from each of the different clusters; and
use the representative training data to train the machine learning model.

18. The system of claim 17, wherein using the representative training data to train the machine learning model includes performing principal component analysis or random projections to reduce a dimensionality of the machine learning model.

19. The system of claim 11, wherein the processor is further configured to delete the received content within a content retention policy period but store the representative embedding beyond the content retention policy period.

20. A computer program product embodied in a non-transitory computer readable medium and comprising computer instructions for:
receiving content for security analysis;
sampling a portion of the received content to determine a set of representative tokens;
embedding at least the set of representative tokens to determine a representative embedding; and
applying the representative embedding to a machine learning model to classify the received content for the security analysis.
